(19) United States
(12) Patent Application Publication
(10) Pub. No.: US 2023/0213156 A1
(43) Pub. Date: Jul. 6, 2023

(54) SEAMLESS CONNECTABLE LINEAR LIGHTING

(71) Applicant: LTG LIGHTING LIMITED, Sheung Wan (CN)

(72) Inventors: Dave Boulanger, Hong Kong (CN); Ladd Campbell, Lynnwood, WA (US); David Wilkins, Englewood, CO (US); Wei Wang, Huizhou City (CN)

(21) Appl. No.: 18/092,464

(22) Filed: Jan. 3, 2023

Related U.S. Application Data
(60) Provisional application No. 63/295,960, filed on Jan. 3, 2022.
(60) Provisional application No. 63/301,514, filed on Jan. 21, 2022.

(51) Int. Cl. F21S 4/28; F21V 21/005; F21S 8/04; F21S 8/06; F21V 23/00; F21V 17/04

(52) U.S. Cl. CPC F21S 4/28; F21V 21/005; F21S 8/043; F21S 8/061; F21V 23/005; F21V 17/04; F21Y 2115/10

(57) ABSTRACT

A lighting system is disclosed herein. The lighting system can include light module for surface, recessed or pendant mounting. The module can include a channel having side walls and an open top and can extend between first and second ends. The module can also include an array of light emitting diodes disposed in the channel and a driver for controlling the light emitting diodes. The module can also include a lens mountable in the open top and a cap selectively engageable with at least one of the first and second ends. The cap can be removed from one of the ends when the module is interconnected with a second light module. The system can also include any one or more of a linking bracket, a positioning bracket assembly, tools for assembling the lens to the channel, and a control module.

### CROSS-REFERENCE TO RELATED APPLICATIONS

This application claims the benefit of U.S. Provisional Patent Application Ser. No. 63/295,960 for a SEAMLESS CONNECTABLE LINEAR LIGHTING, filed on Jan. 3, 2022, which is hereby incorporated by reference in its entirety. This application also claims the benefit of U.S. Provisional Patent Application Ser. No. 63/301,514 for a SEAMLESS CONNECTABLE LINEAR LIGHTING, filed on Jan. 21, 2022, which is also hereby incorporated by reference in its entirety.

### BACKGROUND

### 1. Field

The present disclosure relates to lighting devices or fixtures operable to emit light.

### 2. Description of Related Prior Art

DE102015015071B4 discloses a Straight Connection System for Profiles, a longitudinal connection system for profiles having a substantially U- or double T-shaped cross-section, the profile having bottom and side walls, in particular for light-emitting diodes arranged in strips, the profile having means for positively and/or frictionally fastening a shutter, and also having grooves formed in the side walls of the profile. According to the invention, a connecting means is provided in the region of the connecting portions of the rear side of the floor, respectively. The connecting means are of complementary construction, a first one of the connecting means being formed as a lug-like extension extending from the rear of the floor and a second one of the connecting means being formed as a tongue with an opening for receiving the lug-like extension. Furthermore, a slide-type connector is insertable in the grooves of the profile, which connector is displaceable in the region of the connecting portions and acts as a locking slide, blocking the connecting means against disengagement.

EP427498B1 discloses a ceiling recess cage. A spacer device is provided for use with a recessed light fitting to ensure a minimum spacing between the light fitting and any structural member located above or behind a panel mounting the light fitting. The device consists of a frame-like structure with two or more members which are movable relative to each other, e.g. by pivoting, to allow the device to be adjusted between a collapsed condition in which it can be introduced through the hole in the panel to an expanded condition. A spring can be included to ensure automatic expansion and the device can engage the hole to ensure correct positioning relative thereto.

EP3763992A1 discloses a LIGHTING SYSTEM AND DEVICE CARRIER FOR SUCH A LIGHTING SYSTEM, related to light systems comprising at least one longitudinally elongated support rail and at least one longitudinally elongated device carrier, the support rail having, in cross-section perpendicular to the longitudinal extension, a bottom portion from which laterally spaced and vertically extending side portions extend and the cross-section of the support rail is vertically open, and the device carrier has, in cross-section perpendicular to the longitudinal extension, a bottom portion from which laterally spaced and vertically extending side portions extend and the cross-section of the device carrier is vertically open, and wherein, in the mounted position and device carrier side means are longitudinally parallel and aligned to each other, and facing towards an interior, and supporting rail and supporting rail and supporting rail and, in the respective end portions of the end portions of the side of the device side of the connected to the device side. The disclosure also relates to a device support for such a lighting system.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lighting system is disclosed herein. The lighting system can include at least one light module configured to mount to a ceiling in any one of a surface mount arrangement, a recessed mount arrangement, and a pendant mount arrangement. The at least one light module can include a channel having a bottom wall, first and second side walls projecting away from the bottom wall to respective first and second distal ends, and an open top defined between the first and second distal ends. The channel can have a central axis and can extend along the central axis between a first end and a second end. The channel can also include a plurality of punch outs defined in the bottom wall. Each of the plurality of punch outs can be configured to facilitate one of the surface mount arrangement, the recessed mount arrangement, and the pendant mount arrangement. The at least one light module can also include an array of light emitting diodes (LEDs) disposed in the channel and arranged along the central axis and directed toward the open top such that at least a portion of light emitted by the LEDs emanates out of the open top. The lighting system can also include a driver for controlling power directed to the array of LEDs. The at least one light module can also include a lens mountable in the open top between the first and second distal ends. The at least one light module can also include at least one cap selectively engageable with at least one of the first end and the second end of the channel. The at least one cap can be removed from the at least one of the first end and second end of the channel when the at least one light module is interconnected with a second light module.

### BRIEF DESCRIPTION OF THE DRAWINGS

The detailed description set forth below references the following drawings:

FIG. 1A is an isometric view of a portion of a lighting system in the form of a light module suspended from a ceiling, also known as a pendant mounting arrangement;

FIG. 1B is an isometric view of the light module mounted against the surface of a ceiling, a surface mounting arrangement;

FIG. 1C is an isometric view of the light module to be partially recessed in a ceiling, wherein a dash line represents an edge of an aperture in a ceiling, thus a recessed mounting arrangement;

FIG. 2 is an exploded view of the exemplary light module;

FIG. 3A is a first detail view of a portion of a housing assembly of the light module;

FIG. 3B is a first detail view of a portion of a light emitting diode (LED) assembly of the light module;

FIG. 3C is a second detail view of a portion of the LED assembly of the light module;

FIG. 4 is an end view of the light module with an end cap removed;

FIG. 5A is an isometric view of a first linking bracket operable to interconnect two light modules;

FIG. 5B is a side view of the first linking bracket;

FIG. 6A is an exploded view of a second linking bracket operable to interconnect two light modules;

FIG. 6B is an isometric view of the second linking bracket;

FIG. 7 is an exploded view of the light module in the pendant mounting arrangement;

FIG. 8 is an exploded view of the light module when it is to be at least partially recessed in a ceiling;

FIG. 9 is an exploded view of a positioning bracket assembly used in mounting the light module when it is to be at least partially recessed in a ceiling;

FIG. 10A is a isometric view of the exemplary light module being mounted at least partially recessed in the ceiling;

FIG. 10B is a detail portion of FIG. 10A;

FIG. 10C is a side view of the positioning bracket assembly;

FIG. 10D is an isometric view of the positioning bracket assembly in a first configuration;

FIG. 10E is an isometric view of the positioning bracket assembly in a second configuration;

FIGS. 11A-11C are views associated with removing the light module from the ceiling;

FIG. 12 shows a lens of the exemplary light module being assembled to the housing assembly;

FIG. 13 is an isometric view of a tool shown in FIG. 12 that is used to install the lens;

FIG. 14 is an exploded view the tool shown in FIGS. 12 and 13;

FIG. 15A is an isometric view of another embodiment of the present disclosure;

FIG. 15B is a detail view from FIG. 15A;

FIG. 16 is an exploded view of a control module shown in FIGS. 15A and 15B;

FIG. 17 is an isometric view of the control module shown in FIGS. 15A, 15B and 16;

FIG. 18 is an isometric view of a portion of a lighting system in the form of a light module suspended from a ceiling according to another embodiment of the present disclosure;

FIG. 19 is an isometric view of a portion of a U-shaped channel according to the embodiment of the present disclosure shown in FIG. 18;

FIGS. 20A-20F are views of a second tool used to install a lens; and

FIG. 21 is a perspective view of another portion of the U-shaped channel shown in FIG. 19.

### DETAILED DESCRIPTION

Similar structural features are shown in the Figures of the present disclosure and have been numbered with a common reference numeral and have been differentiated by an alphabetic suffix. Similar structural features in a particular Figure have been numbered with a common two-digit, base reference numeral and have been differentiated by a different leading numeral. Similar features are structured similarly, operate similarly, and/or have the same function unless otherwise indicated by the drawings or this specification.

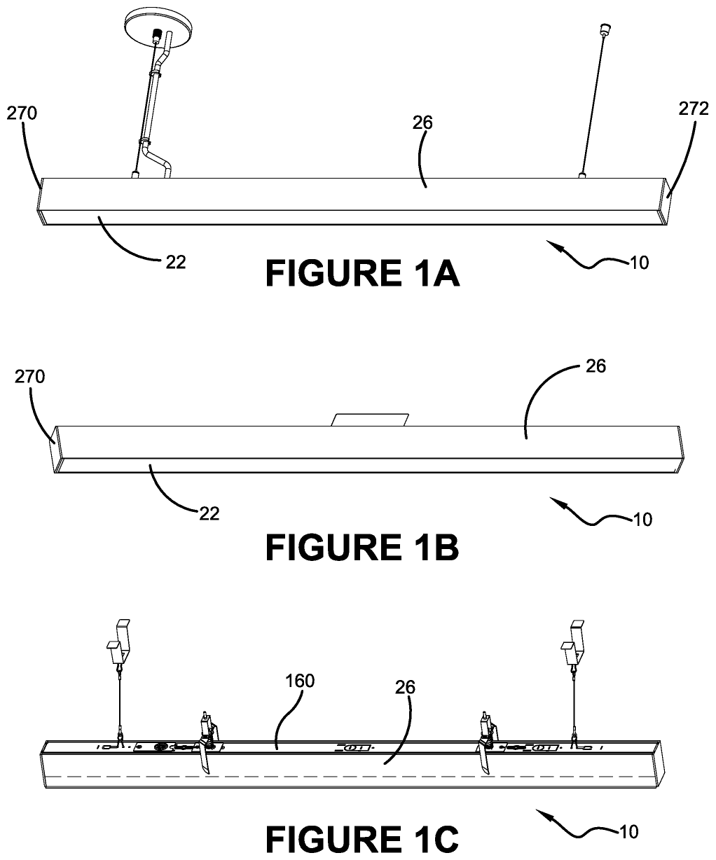

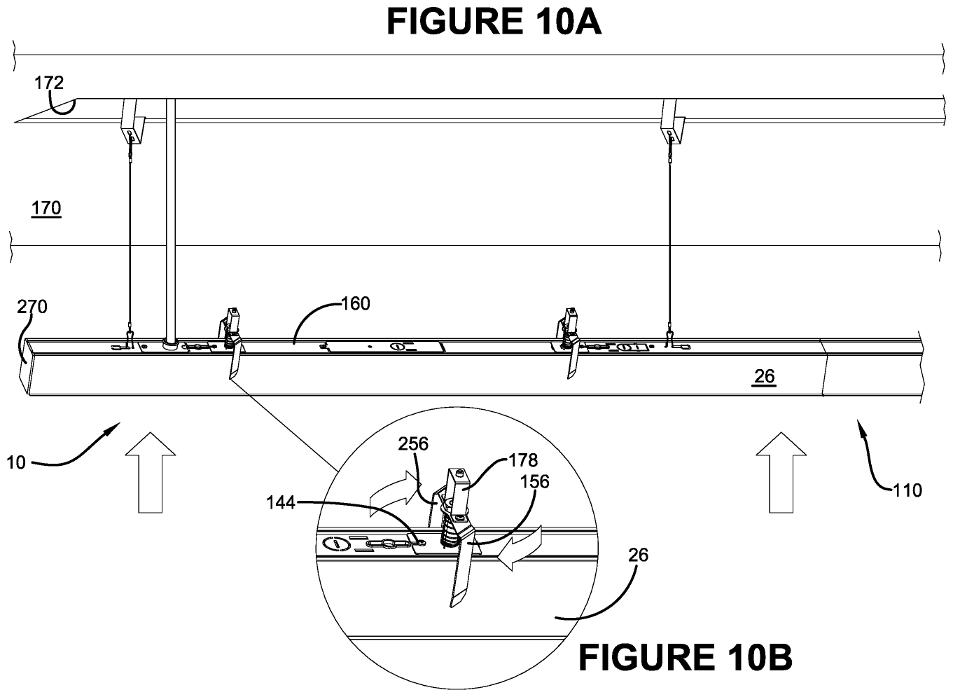

The present disclosure provides an exemplary lighting system that can include a light module. An exemplary embodiment of the light module is referenced at 10. FIG. 1A is an isometric view of the linear light module 10 mounted in a pendant mounting arrangement, suspended from a ceiling (a ceiling 170 is referenced in FIG. 10A). FIG. 1B is an isometric view of the light module 10 mounted in a surface mounting arrangement, against the surface of the ceiling 170. FIG. 1C is an isometric view of the light module 10 mounted in a recessed mounting arrangement, at least partially recessed in a ceiling 170. The dash line in FIG. 1C represents an edge of an aperture in the ceiling 170. The light module 10 can be connected end-to-end with another light module to define a substantially seamless, longer light module. FIG. 10A shows two light modules 10, 110 interconnected with one another, end-to-end, and also shows a relatively small line where the two modules 10, 110 meet.

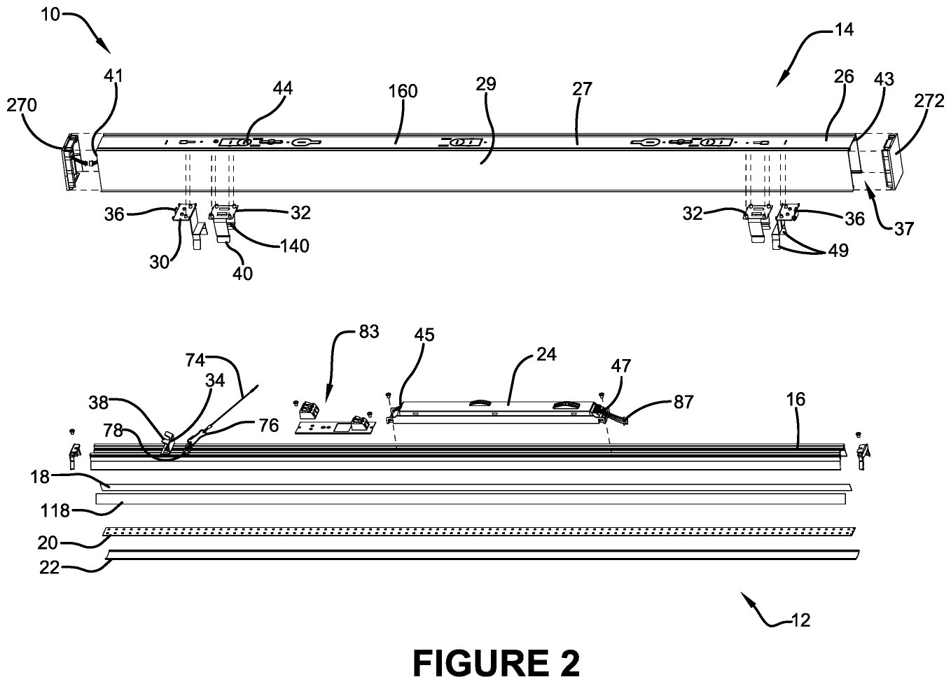

FIG. 2 is an exploded view of the exemplary light module 10. The light module 10 includes an LED assembly 12 and a housing assembly 14. The LED assembly 12 includes a spine 16, deflector strips 18 and 118 mounted to the spine 16, a printed circuit board (PCB) and LED array 20 mounted to the spine 16, a lens 22, and a driver 24 for driving the LEDs of the PCB/LED array 20 and mounted to the spine 16. The driver 24 controls the electrical power and current directed to the array 20 of LEDs. The LED assembly 12 can also include a wire/cord 74, carabiner 76, and anchor bracket 78 fastened to the spine 16, which can be utilized as a temporary suspension assembly for the light module 10 during mounting.

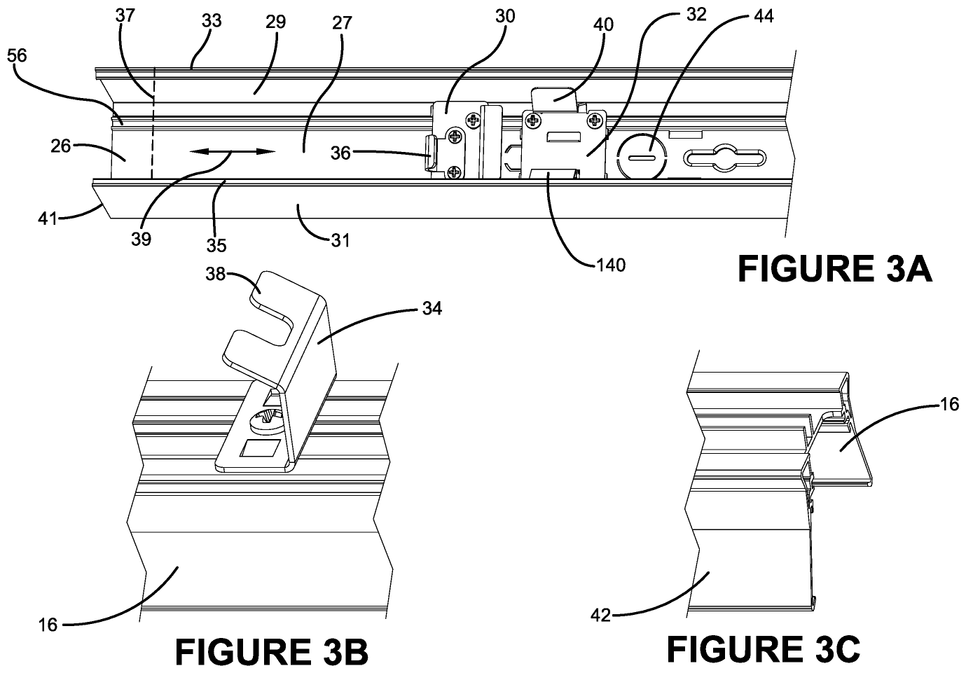

The housing assembly 14 includes a U-shaped channel 26. The exemplary channel 26 includes a bottom wall 27, first and second side walls 29, 31 that project away from the bottom wall 27 to respective first and second distal ends 33, 35, and a mouth or open top 37 defined between the first and second distal ends 33, 35. The exemplary channel 26 extends along a central axis 39 (see FIG. 3A) between a first end 41 and a second end 43. The exemplary channel 26 further comprises a plurality of punch outs 44, 85, 149 defined in the bottom wall. Each of the exemplary plurality of punch outs is configured to facilitate one of a surface mount arrangement, a recessed mount arrangement, and a pendant mount arrangement and/or to permit the passage or wiring through the channel 26.

The spine 16, deflector strips 18 and 118, PCB/LED array 20, and driver 24 are received in the channel 26. The LEDs are arranged along the central axis 39 and directed toward the open top 37 such that at least a portion of light emitted by the LEDs emanates out of the open top 37. The lens 22 is mounted to extend across the open top 37 of the channel 26 between the first and second distal ends 33, 35 and between the ends 41 and 43. It is noted that a lens can be longer than a single light module in operating environments in multiple light modules are interconnected end-to-end so that a single lens can cover the open tops of all of the multiple light modules.

Referring now to FIGS. 3A-3B, the housing assembly 14 also includes at least one connecting bracket 30 and at least one connecting bracket 32. The LED assembly 12 also includes at least one connecting bracket 34. The exemplary connecting bracket 30 includes a hook portion 36 that engages a hook portion 38 of the exemplary connecting bracket 34 to assist in connecting the spine 16 and the channel 26. The connecting bracket 32 includes spring arms 40 and 140 having a shape that corresponds to the shape of the spine 16. The arms 40, 140 engage the outer profile of the spine 16 to assist in connecting the spine 16 and the channel 26. The bracket 34 also includes a pair of spring arms (both referenced by 49 in FIG. 2) that can engage the outer profile of the spine 16 to assist in connecting the spine 16 and the channel 26. The outer profile of the spine 16 is referenced at 42 in FIG. 3C.

Referring again to FIG. 2, exemplary end caps 270, 272, are selectively engageable with at least one of the first end 41 and second end 43 of the channel 26. Each of the exemplary caps 270, 272 can be removed as desired from the first end 41 and/or the second end 43 of the channel 26 when the light module 10 is interconnected with a second light module.

Although not shown in FIG. 2, wiring can extend from the PCB/LED array 20 and to the driver 24 whereby electrical power is directed to the LEDs of the PCB/LED array 20. Wiring from the driver 24 can extend out of the housing assembly 14 if desired to connect to a power source. FIG. 3A shows a punch out portion for wiring at 44 that can be removed if desired to act as a pass-through for wiring. A “punch out” is a portion of the bottom wall 27 that is connected to a remainder of the bottom wall 27 along a small percentage of its periphery so that it can be relatively easily removed from the remainder of the bottom wall 27 if desired. A punch out can be removed to accommodate different mounting arrangements and/or to accommodate the pass-through of some other structure such as wiring or mounting hardware.

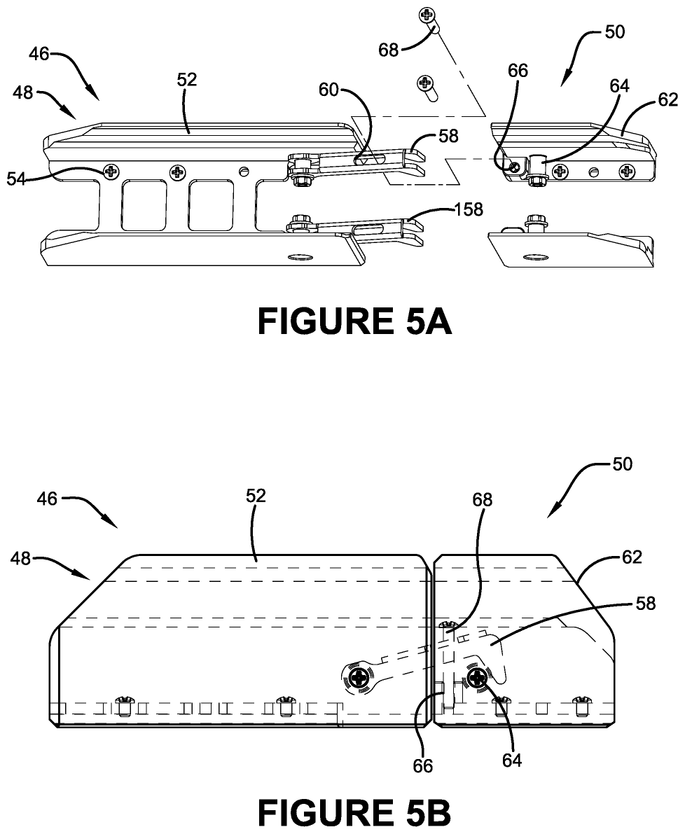

The light module 10 is configured to be modular, wherein a plurality of light modules 10 can be interconnected together. FIG. 5A is an isometric view of a first linking bracket assembly 46 operable to interconnect two light modules 10. FIG. 5B is a side view of the first linking bracket assembly 46. The exemplary first linking bracket assembly 46 includes a first half 48 and a second half 50. The first half 48 includes a frame 52 that can be fixed to the channel 26 with fasteners, such as fastener 54. The fastener 54 can extend through an aperture in the frame 52 and into a track 56 defined by the channel 26. The first half 48 also includes a pair of hook arms 58 and 158 pivotally mounted on the frame 52. Each hook arm 58, 158 includes an aperture, such as aperture 60.

The second half 50 includes a frame 62 that can be fixed to the channel 26 with fasteners through the track 56 defined by the channel 26. The second half 50 also includes a pair of posts, such as post 64, extending from the frame 62. The second half 50 also includes threaded apertures adjacent to the posts, such as aperture 66.

In operation, the first half 48 can be mounted on the channel 26 of a first light module and the second half 50 can be mounted on the channel 26 of a second light module. The first and second light modules can be aligned and positioned proximate to one another so that the arms 58, 158 can be rotated over the posts on the second half 50. Next, fasteners, such as fastener 68, can be inserted through the apertures (such as aperture 60) in the hook arms (58, 158) and also threaded into the apertures (such as aperture 66) in the frame 62. As the fastener 68 is turned to move deeper into the apertures in the frame 62, the fastener 68 urges the hook arm 58 downward. The hook arm 58 and post 64 operate as a cam/cam-follower and as the hook arm 58 is moved downward the halves 48, 50 are drawn together.

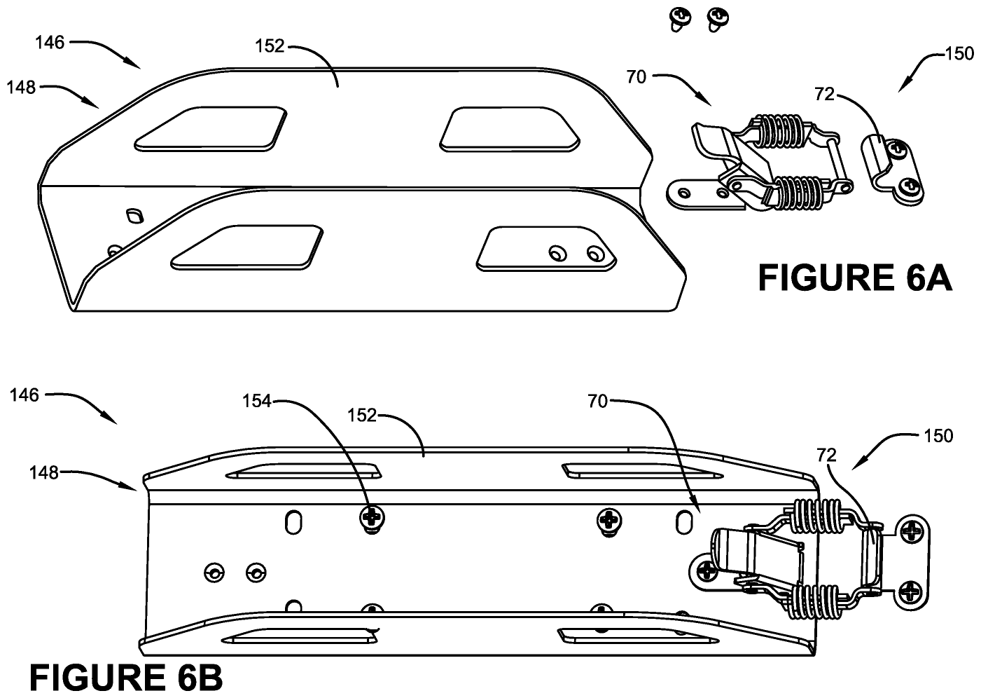

FIG. 6A is an exploded view of a second linking bracket assembly 146 operable to interconnect two light modules and FIG. 6B is a side view of the second linking bracket assembly 146. The exemplary second linking bracket assembly 146 includes a first half 148 and a second half 150. The first half 148 includes a frame 152 that can be fixed to the channel 26 with fasteners, such as fastener 154. The fastener 154 can extend through an aperture in the frame 152 and into the track 56 defined by the channel 26. The first half 148 also includes a spring-biased over-center latch 70 pivotally mounted on the frame 152. The second half 150 can be fixed to the channel 26 of the second light module with fasteners through the track 56 defined by the channel 26. The second half 150 includes a hook portion 72. In operation, the over-center latch 70 is selectively engageable with the hook portion 72 and can engage the hook portion 72 to draw and hold two first modules 10 together.

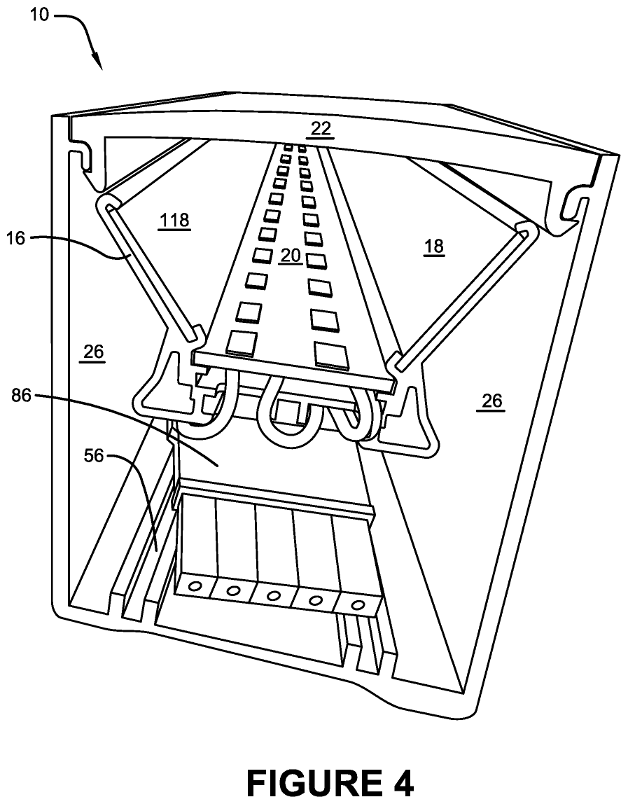

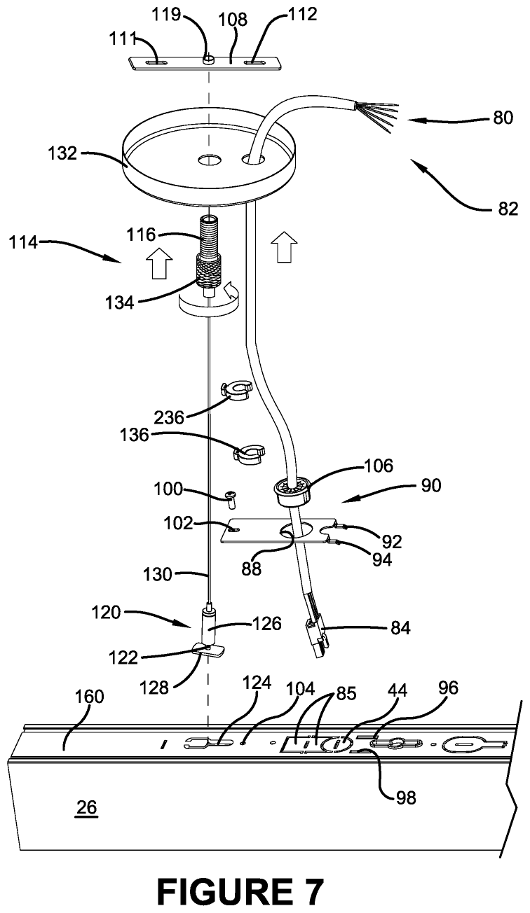

FIG. 7 is an exploded view of the light module 10 to be suspended from the ceiling 170. The exemplary light module 10 includes a wire harness 80 including a first end 82 with exposed wires for connection in a junction box and a plug connector 84 at a second end opposite to the first end 82. The plug connector 84 can mate with a plug connector 86 (FIG. 4) that electrically connects the driver 24, which electrically connects to the PCB/LED array 20. The light module 10 could include an electrical connector 83 as an alternative to plug connector 86 or as a supplemental/additional connector. Wiring (not shown) could extend from the driver 24 to the connector 83.

It is noted that the exemplary light module 10 includes plug connectors at both ends 41 and 43 so that a string of light modules 10 can be interconnected with one another and receive power from a single junction box. Wires can extend from the plug connector 86 to a first end 45 (referenced in FIG. 2) of the driver 24 to communicate electrical power to the driver 24. Wires can also extend from a second end 47 of the driver 24 and terminate at a male plug 87 like female plug 86. This plug 87 could engage a plug like plug 86 of an adjacent light module. It is noted that power and data signals can be communicated through a series of such interconnections so that a series of interconnected light modules can be powered by a single junction box and can be controlled by a single control module as disclosed below.

To extend the plug connector 84 into the channel 26, the punch out 44 can be removed. A punch out 85 (referenced in FIG. 7) can also be removed. The punch outs 44, 85 are connected to the remainder of the channel 26 via narrow webs and so can be removed relatively easily with a hand tool. After the plug connectors 84, 86 are connected, the first end 82 of the wire harness 80 can be strung through an aperture 88 in a hatch piece 90. A grommet 106 can also be positioned in the aperture 88 to protect the wire harness 90 from the edge of the aperture 88. Arms 92, 94 of the hatch piece 90 can then be received in apertures 96, 98 in the channel 26. A fastener 100 can then be extended through an aperture 102 in the hatch piece 90 and screwed into an aperture 104 in the channel 26 to fix the hatch piece 90 to the channel 26.

For supporting the weight of the exemplary light module 10 with a junction box, the exemplary light module 10 can include a bracket 108 that can be fastened to the junction box with fasteners extending through apertures 111, 112. The exemplary light module 10 can also include a suspension assembly 114 to interconnect the channel 26 and the bracket 108, while permitting a distance between the channel 26 and the bracket 108 to be varied.

At an upper end (when installed), the exemplary suspension assembly 114 includes a threaded shank 116 that can be threadingly engaged with a threaded aperture 119 of the bracket 108. The exemplary suspension assembly 114 also includes a linking assembly 120 at a lower end. The linking assembly 120 includes a T-member 122 that can be inserted in a slit 124 in the channel 26. A weight of the exemplary light module 10 can rest on a flange portion 128 of the T-member 122. The linking assembly 120 also includes a locking cylinder 126 that is movably engaged with the T-member 122. For example, a distance between the flange portion 128 of the T-member 122 and the locking cylinder 126 can be maximized when the T-member 122 is being inserted in the slit 124 in the channel 26. Subsequently, the distance between the flange portion 128 of the T-member 122 and the locking cylinder 126 can be minimized to pinch the channel 26 between the flange portion 128 of the T-member 122 and the locking cylinder 126. In one or more embodiments, the T-member 122 and the locking cylinder 126 could be interconnected by threads. The exemplary suspension assembly 114 also includes a wire/cord 130 interconnecting the threaded shank 116 and the linking assembly 120.

The exemplary light module 10 can also include an aesthetic trim piece 132 positionable at the ceiling 170. The threaded shank 116 and the first end 82 of the wire harness 80 can extend through apertures in the trim piece 132. The exemplary light module 10 can also include an aesthetic nut 134 threadingly engageable with the threaded shank 116 to maintain the trim piece 132 in position at the ceiling 170. The exemplary light module 10 can also include clips 136, 236 to interconnect the wire harness 80 and the wire 130.

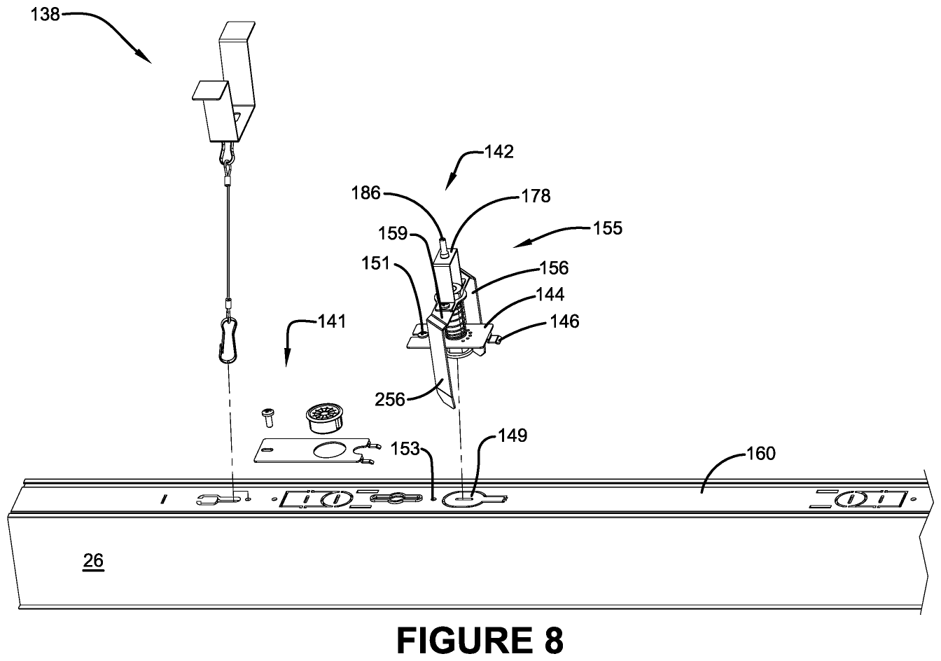

FIG. 8 is an exploded view of the light module 10 to be partially recessed in a ceiling 170. A suspending bracket 138 can be placed in a rectangular aperture in the ceiling 170 and used to temporarily suspend the light module 10. Structures referenced at 141 are configured to facilitate the interconnection of a wire harness to the light module 10. FIG. 8 also shows a positioning bracket assembly 142 configured to hold the channel 26 and transfer the weight of the channel 26 to an upper side (a hidden side, upwardly facing surface) of the ceiling 170.

The exemplary positioning bracket assembly 142 can be engaged with a mounting plate 144 having a tongue 147 that is insertable in an aperture defined in the bottom wall 27 of the channel 26 when the punch out 149 is removed. The positioning bracket assembly 142 could be engaged directly with the bottom wall 27 in other embodiments. The tongue 147 can be received in a narrow portion defined by the aperture created in the channel 26 when the punch out 149 is removed. After the tongue 147 is received in the narrow portion, the mounting plate 144 can be fastened to the channel 26 with a fastener 151 extending through an aperture 153 in the bottom wall 27 of the channel 26.

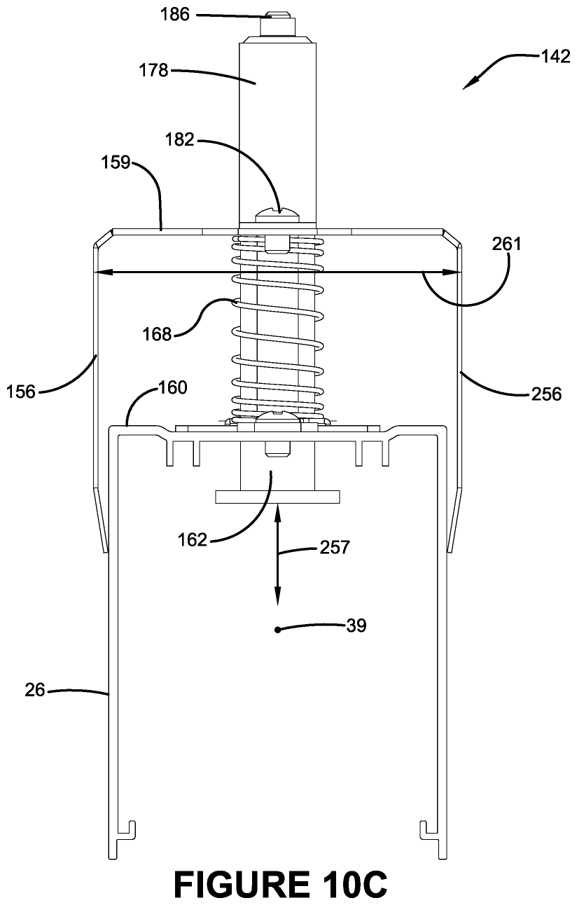

The positioning bracket assembly 142 includes a weight-transfer yoke 155. The yoke 155 includes arms 156, 256 and a base 159 from which the arms 156, 256 extend. The positioning bracket assembly 142 can also include a shaft 162 extending through the base 159 and the mounting plate 144. The weight of the light module 10 can be transmitted to the upwardly-facing surface of the ceiling 170 through the plurality of exemplary arms 156, 256. Each of the plurality of exemplary arms 156, 256 at least partially overlaps one of the first and second side walls 29, 31 along a center axis 257 of the exemplary shaft 162, as best shown in FIGS. 10C and 11A. A nut 176 can prevent the shaft 162 and the base 159 from separating by threadingly engaging a threaded end of the shaft 162. The shaft 162 can maintain the base 159 in an orientation that is substantially parallel to a top surface 160 of the channel 26. The shaft 162 can extend through aligned apertures 164, 166 of the base 159 and the mounting plate 144, respectively.

The exemplary shaft 162 is engaged with the mounting plate 144 such that the exemplary shaft 162 can rotate relative to the mounting plate 144. The exemplary shaft 162 is engaged with the base 159 such that the exemplary shaft 162 cannot rotate relative to the base 159. The exemplary shaft 162 and exemplary yoke 155 are thus engaged for concurrent rotation. The cross-section of the exemplary shaft 162 within the aperture 164 and the aperture 164 are keyed. The exemplary base 159 and exemplary shaft 162 can rotate together relative to the mounting plate 144.

The positioning bracket assembly 142 also includes a spring 168 operably positioned between the yoke 155 and the channel 26. The exemplary yoke 155 and the exemplary shaft 162 are rotationally engaged to move between first and second end limits of travel relative to the exemplary channel 26. The exemplary spring 168 is operably disposed between the base 159 and the mounting plate 144 to torsionally bias the yoke 155 to the first end limit of travel that is shown in FIGS. 8 and 11A-11C. One end of the spring 168 can be fixed to the yoke 155 or shaft 162 and the other end of the spring 168 can be fixed to the mounting plate 144. The exemplary spring 168 also axially biases the base 159 and bottom wall 27 apart while torsionally biasing the yoke 155 into the position shown in FIGS. 8 and 11A-11C.

As best shown in FIGS. 10A and 10B, after the positioning bracket assembly 142 has been attached to the channel 26 and when the light module 10 is to be mounted to the ceiling 170, the arms 156, 256 can be grasped by the installer and the yoke 155 can be rotated about the center axis 257 of the shaft 162 from the position shown in FIGS. 8 and 11A-11C to the position shown best in FIG. 10C. The yoke 155 is shown in the second end limit of rotational travel in FIG. 10C. This elastically deforms the spring 168 and stores energy in the spring 168. This also minimizes the width of the profile of the light module 10, as will be described further below. The light module 10 can then be raised into an aperture 172 in the ceiling 170. When the light module 10 has been raised sufficiently such that the arms 156, 256 clear the upwardly-facing surface of the ceiling 170, the spring 168 recovers and rotates the base 159 and the arms 156, 256 to the position shown in FIGS. 8 and 11A-11C. The distal tips of the arms 156, 256 can then rest on the upper surface of the ceiling 170. The weight of the light module 10 is thus supported on the upwardly-facing of the ceiling 170. It is also noted that FIG. 10A shows a second light module 110 interconnected to the light module 10.

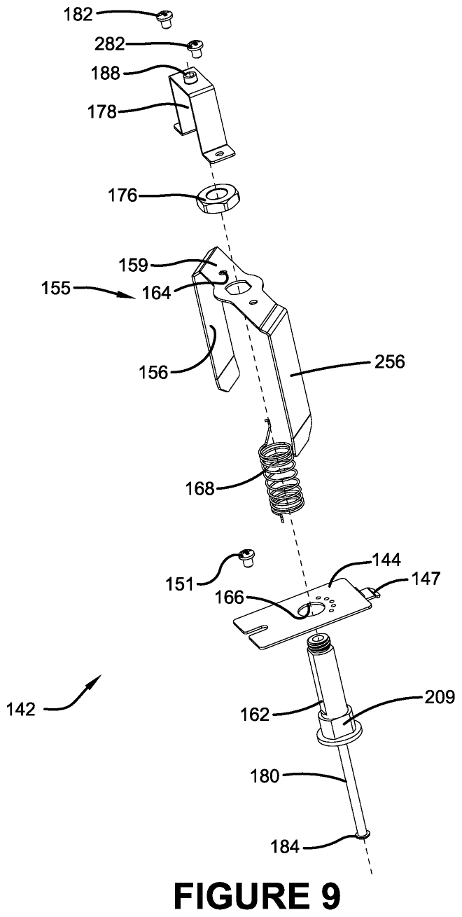

The exemplary positioning bracket assembly 142 is also configured to permit adjustment of the extent that the light module 10 projects through the aperture 172 in the ceiling 170. As best shown in FIG. 9, the exemplary positioning bracket assembly 142 also includes a secondary yoke 178 and a secondary shaft 180. The exemplary secondary yoke 178 is mounted to the base 159 with fasteners 182, 282. The secondary shaft 180 extends through the inside of the shaft 162 and is rotatable relative to the shaft 162. The secondary shaft 180 includes a head 184 at a first end that prevents the secondary shaft 180 from passing fully through the shaft 162. The head 184 can include a standard or Phillips groove in order to be engaged by a tool for turning. The secondary shaft 180 is threaded at a second end 186 and the second end 186 can be threadingly received in a threaded aperture 188 of the secondary yoke 178. An extent of the axial compression of the exemplary spring 168 increases in response to rotation of the second exemplary shaft 180 in a first direction and decreases in response to rotation of the second exemplary shaft 180 in a second direction opposite the first direction.

FIG. 10D is an isometric view of the positioning bracket assembly 142 in a first configuration. In the first configuration, a tip 190 of the arm 156 is a distance D1 from the distal end 33 of the side wall 29 channel 26. The base 159 is a distance D2 from the top surface 160 (bottom wall 27) of the channel 26. When the positioning bracket assembly 142 is in the first configuration, the light module 10 will be generally less recessed into the ceiling 170.

FIG. 10E is an isometric view of the positioning bracket assembly 142 in a second configuration. The positioning bracket assembly 142 is converted from the first configuration to the second configuration by the turning the secondary shaft 180 so that more of the shaft 180 passes through the threaded aperture 188. In the second configuration, the tip 190 of the arm 156 is a distance D3 from the distal end 33 and distance D3 is less than distance D1. The base 159 is a distance D4 from the top surface 160 and distance D4 is less than distance D2. When the positioning bracket assembly 142 is in the second configuration, the light module 10 will be generally more recessed into the ceiling 170. Thus, an extent of the overlap of the plurality of exemplary arms 156, 256 and the exemplary first and second side walls 29, 31 along the center axis 257 of the exemplary shaft 162 increases in response to rotation of the second exemplary shaft 180 in a first direction (as the shaft 180 is further screwed into the aperture 188) and decreases in response to rotation of the second exemplary shaft 180 in a second direction opposite the first direction (as the shaft 180 unscrewed out of the aperture 188).

FIGS. 10C and 11A are views taken in a first plane that is normal to the central axis 39 of the channel 26 and also contains or is parallel to the center axis 257 of the exemplary shaft 162. As shown in FIG. 11A, a first width 259 is defined between respective outer edges of the plurality of exemplary arms 156, 256 in the first plane when the exemplary yoke 155 and the exemplary shaft 162 are at the first end limit of travel. As shown in FIG. 10C, a second width 261 is defined between respective outer edges of the plurality of exemplary arms 156, 256 in the first plane when the exemplary yoke 155 and the exemplary shaft 162 are at the second end limit of travel. The first width 259 is greater than the second width 261. This allows the light module 10 and bracket assembly 142 to be easily moved into the aperture 172 in the ceiling 170 with the aperture 172 being sized substantially the same as the perimeter of the light module 10 while also allowing the bracket assembly 142 to provide a wide engagement with upwardly-facing surface of the ceiling 170. As best shown in FIG. 10C, each of the plurality of exemplary arms 156, 256 includes a respective tip that tapers toward the exemplary channel 26 in the first plane when the exemplary yoke 155 and the exemplary shaft 162 are at the second end limit of travel.

FIGS. 11A-11C disclose rotating the shaft 162 with a tool 174, if the removal of the light module 10 from the ceiling 170 is desired. Tangs 203, 205 of the tool 174 can be directed between a head 205 of the shaft 162 and the bottom wall 27, working into position against the axial biasing force generated by the spring 168. The exemplary shaft 162 defines two, parallel and flat landings (one referenced at 209 in FIG. 9) engaged by tangs 203, 205. After insertion, the tool 174 can then be rotated against the torsional biasing of the spring 168 to move the arms 156, 256 to the orientation shown in FIG. 10C, which is the second end limit of travel. The lighting module 10 can then be lowered from the aperture 172 in the ceiling 170. It is noted that the spine 16 can be selectively released from the spring arms 40, 49, 140 (at one or both ends of connection) in order to access buttons on the driver 24 or to access the positioning bracket assembly 142.

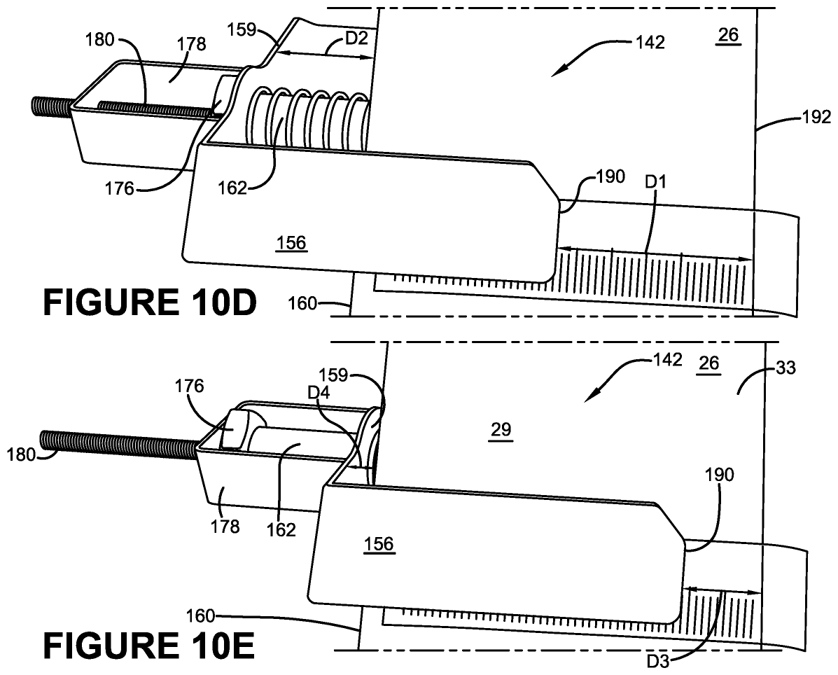

FIG. 12 shows the lens 22 being assembled to the housing assembly 14. The lens 22 can be formed from silicone and have sufficient rigidity to remain in the housing assembly 14 once installed, but also be sufficiently pliable (deformable without damage) to be rolled into a roll. The exemplary lens 22 has a length greater than one light module 10 and can be concurrently unrolled from a role and put into position in the housing assembly 14. Because the exemplary lens 22 has a length greater than one light module 10, the lens 22 can extend over a plurality of light modules and, thus, no seam or gap will be defined where two light modules abut one another. In one or more embodiments, the lens 22 can define a large roll and be cut to length as needed, based on the number of light modules that are interconnected. The roll can be hung from the light modules, supported on a hook 194. As the roll is unwound, the hook 194 can be slid along the length of light modules.

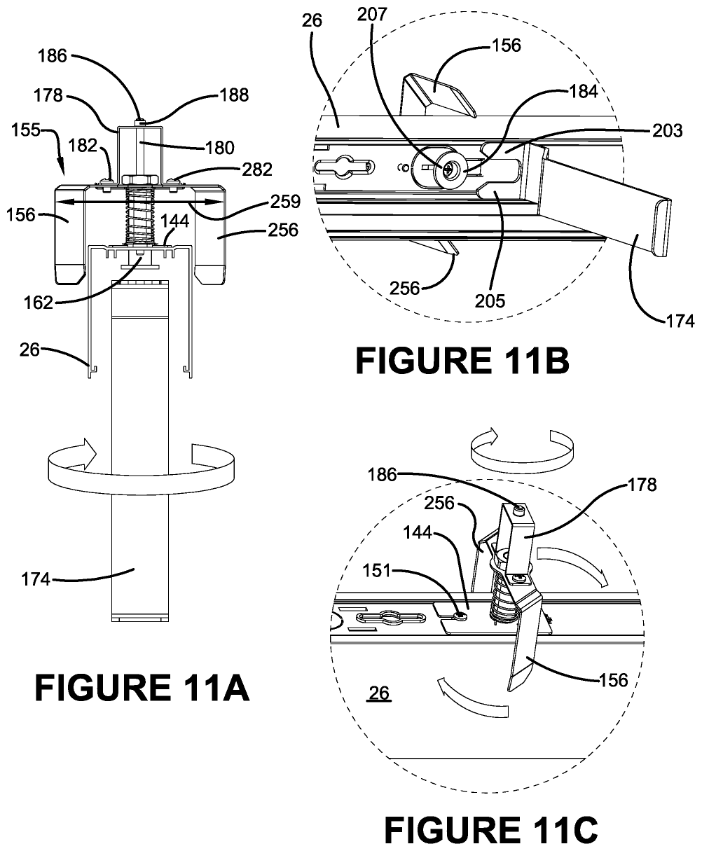

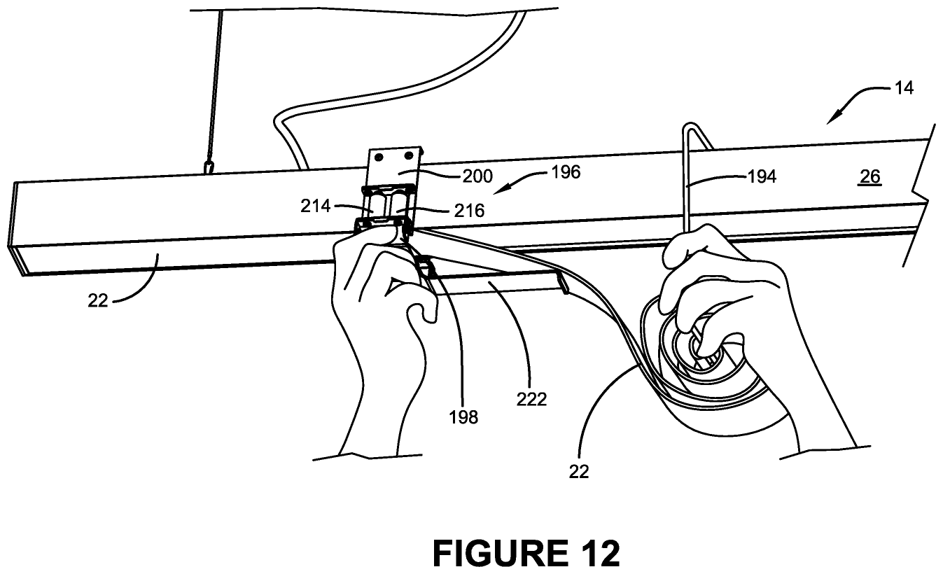

FIG. 12 also shows a tool 196 for use in quickly and accurately guiding the lens 22 into position in the open top 37. FIG. 13 is a isometric view of tool 196 and FIG. 14 is an exploded view. The tool 196 includes a framework formed from various structural members, such as exemplary members 198, 200, 202. Bearings or rollers 204, 206, 208, 212 are mounted on the framework and roll along the top surface 160 of the channel 26 as the lens 22 is being installed, supporting the weight of the tool 196. Bearings or rollers 214, 216, 218, 220 are also mounted on the framework and roll along the lateral surfaces of the channel 26 as the lens is being installed, keeping the tool 196 properly aligned. A tongue 222 extends from the framework along the central axis 39 and supports a portion of the lens 22 that, as the tool 196 moves along the light modules, is about to be positioned in the housing assembly 14. A roller 224 is also mounted and the framework and presses the lens 22 against the housing assembly 14.

Exemplary roller 224 is thus mounted on the framework for rotation about a first axis 195 (referenced in FIG. 14) that is perpendicular to and spaced from the central axis 39 when the framework is positioned on the channel 26 during installation of the lens 22. Exemplary roller 214 is mounted on the framework for rotation about a second axis 197 that is perpendicular to and spaced from the central axis 39 and perpendicular to the first axis 195 when the framework is positioned on the channel 26 during installation of the lens 22. Exemplary roller 218 is mounted on the framework for rotation about a third axis 199 that is perpendicular to and spaced from the central axis 39 and perpendicular to the first axis 195 and parallel to the second axis 197 when the framework is positioned on the channel 26 during installation of the lens 22. Exemplary roller 204 is mounted on the framework for rotation about a fourth axis 201 that is perpendicular to and spaced from the central axis 39 and parallel to the first axis 195 and perpendicular to the second axis 197 and the third axis 199 when the framework is positioned on the channel 26 during installation of the lens 22. During an exemplary installation of the lens 22, the framework is moveable along the channel 26 with the roller 224 rollable along the first and second distal ends 33, 35 and urging the lens 22 into the open top 37, the rollers 218, 214 respectively rollable along the first and second side walls 29, 31, the roller 204 rollable along the bottom wall 27, and the tongue 222 configured to support a portion of the lens 22. The lens 22 can extend longer than the channel 26 and be mountable in the open top of a plurality of light modules.

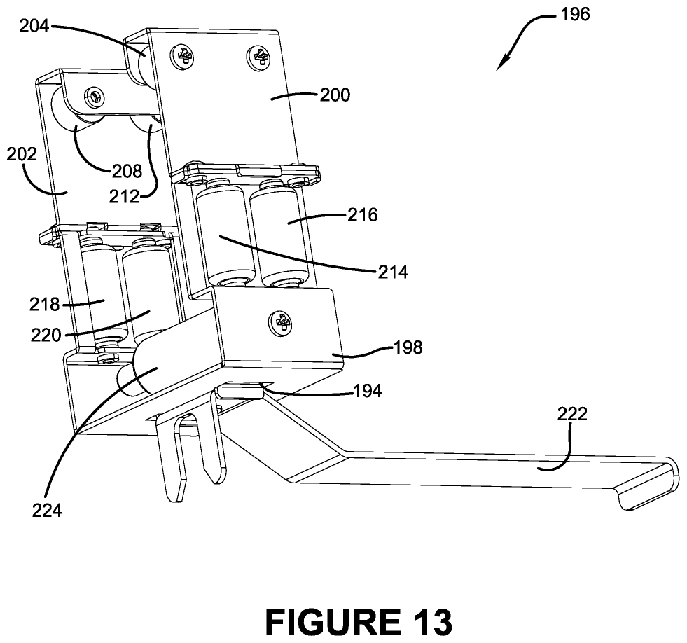

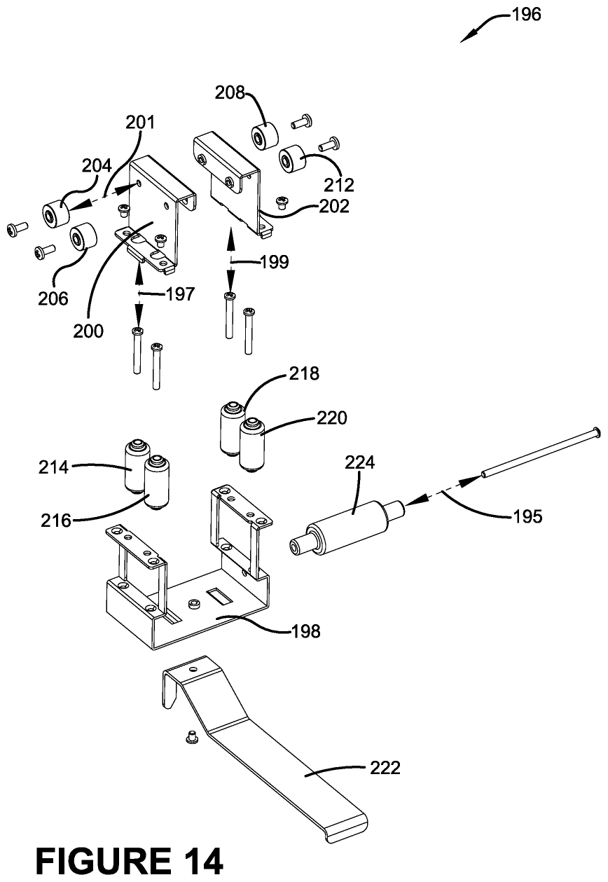

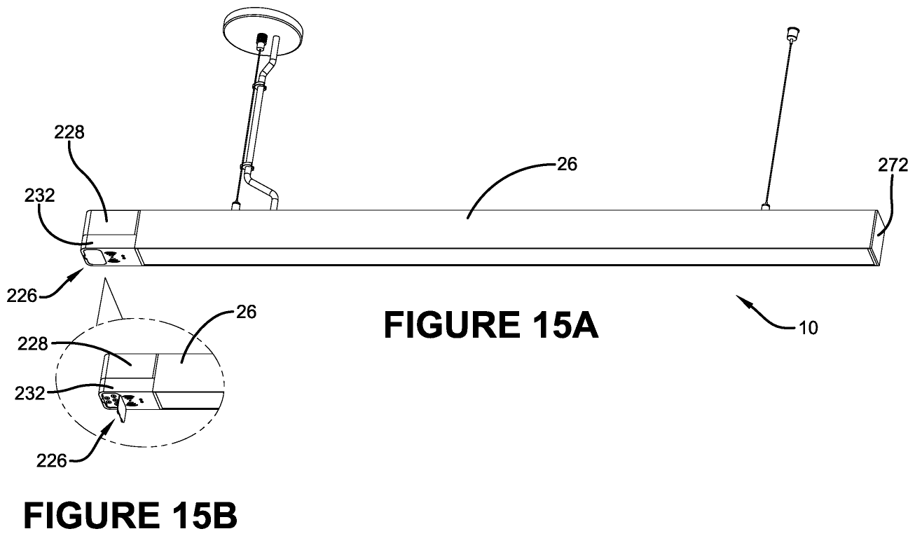

FIG. 15A is an isometric view of another embodiment of the present disclosure and FIG. 15B is a detail view from FIG. 15A. FIG. 16 is an exploded view of a control module 226 of this embodiment and FIG. 17 is an isometric view of the control module 226. The control module 226 includes a first housing portion 228, a second housing portion 230, and a third housing portion 232. The housing portions 228, 230, 232 interconnect with one another, define a cavity, and are configured to slide into an end of the channel 26 instead of an end cap, such as end cap 270 or 272. The exemplary third housing portion 232 defines a recess 234 on its outer surface and apertures, such as aperture 237, within the recess 234.

The exemplary control module 226 also includes a circuit board 238 and input/output wiring 240. The exemplary input/output wiring 240 interconnects the circuit board 238 and the driver 24. The exemplary control module 226 receives a twelve volt input through the input/output wiring 240 from the driver 24 and works with a zero to ten volt signal. The output of the circuitry of the circuit board 238 of the exemplary control module 226 controls the driver 24 in controlling the LEDs. The exemplary control module 226 also includes a light sensor 246 in electronic communication with the circuit board 238. The light sensor 246 can transmit signals representative of the extent/magnitude of light that is sensed. The circuit board 238 can include programming in the form of software and/or hardware responsive to signals received from the light sensor 246 that are representative of the extent/magnitude of light that is sensed. For example, in response to no light being sensed or to a low magnitude of sensed light, the exemplary circuit board 238 transmits control signals to the driver 24 to activate the array 20 of LEDs or increase the current directed to the array 20 of LEDs.

The exemplary control module can be utilized by a user to selectively adjust five functions including (i) detection area, (ii) hold time, (iii) day light threshold, (iv) stand-by period, and (v) stand-by dimming level. These functions will be described in greater detail below. The exemplary driver 24 is also configured such that it can communicate grid power to whatever end is opposite to the electrical input end, in order to deliver grid power to the driver of any light module that is immediately adjacent to the light module 10.

The exemplary control module 226 also includes turn knobs, such as turn knob 242, and a cover 244. The exemplary turn knobs interconnect with the circuit board 238 and thus allow a user to input desired attributes of light emission by turning the turn knobs to particular, respective positions. The exemplary turn knobs can extend through the exemplary apertures in the recess 234, such as aperture 237. The exemplary cover 244 can be pivotally mounted on the third housing portion 232 whereby the cover 244 can be pivoted between a first position closing the recess 234 and turn knobs (shown in FIG. 15A) and a second position in which the recess 234 and turn knobs are exposed (shown in FIG. 15B).

One of the turn knobs can be turned to adjust a detection area, which relates to making a change inside the cavity defined by housing portions whereby a change occurs in the angle between the sensor and the remainder of the housing portions. Another one of the turn knobs can be turned to adjust a hold time, which relates to the time period that the light will continue to emit light after the last reading by the sensor 246. This setting may establish the time period between sampling done by the sensor 246. Another one of the turn knobs can be turned to adjust the daylight threshold, which relates to a predetermined level of ambient light whereby the light will engage if the sensed level is below the predetermined level or disengage if the sensed level is above the predetermined level. Another one of the turn knobs can be turned to adjust a stand-by period, which relates to the time period over which the light will be dimmed after the last sampling of the sensor 246 which indicates that the predetermined level is above the predetermined level. Another one of the turn knobs can be turned to adjust the stand-by dimming level, which relates to the dimming level that the light will keep during the stand-by period.

The control module can also receive signals from a sensor mounted at the opposite end of a series of interconnected light modules. Such a series can include a single control module mounted at one end of the series. A first light sensor can be mounted with the control module at a first end of the series and a second light sensor can be mounted at a second end of the series, opposite the first end of the series. The second light sensor can communicate with the control module. The exemplary driver 26, in addition to facilitating the communication of power, can also facilitate the communication of signals between the control module and the second light sensor.

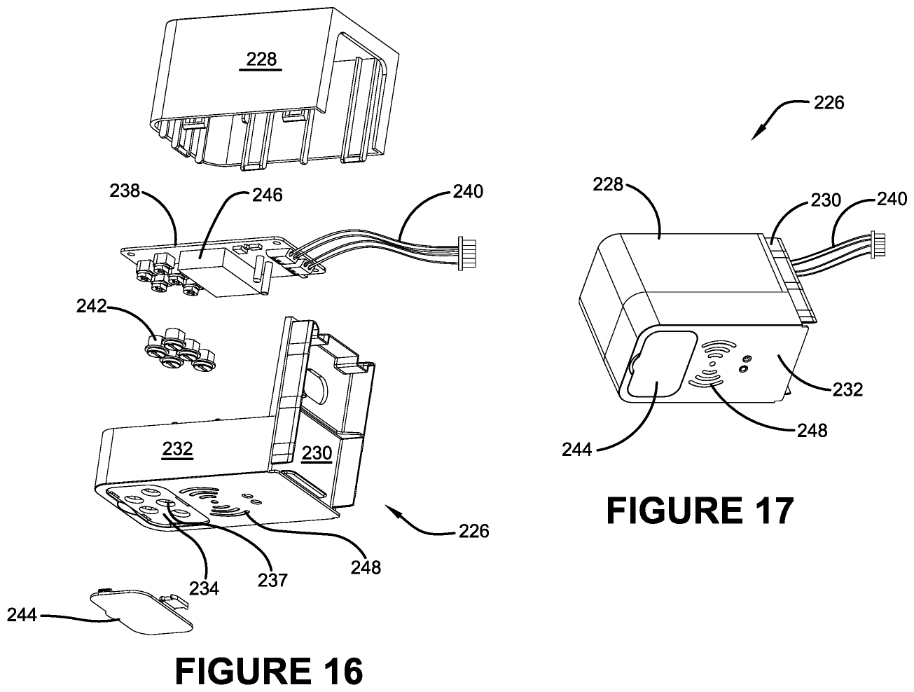

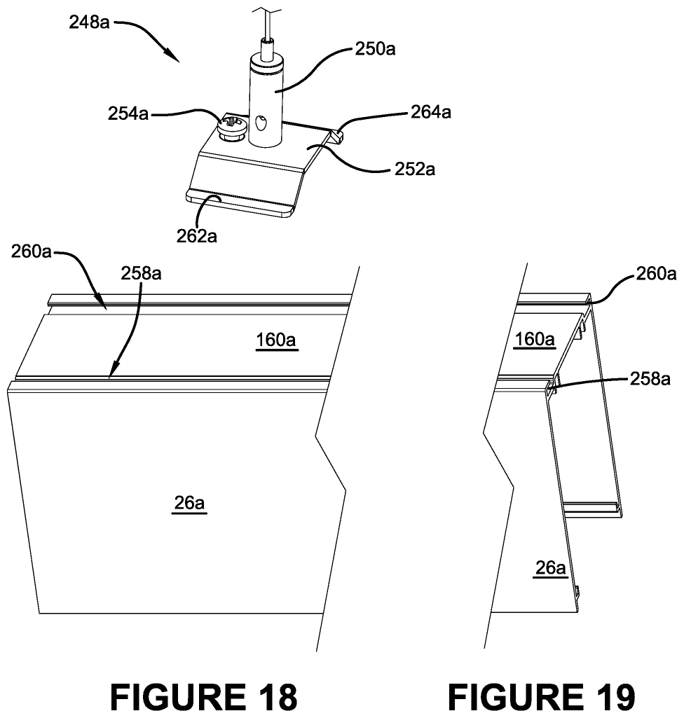

FIG. 18 is an isometric view of a portion of an exemplary lighting system in the form of a light module suspended from the ceiling 170 according to another embodiment of the present disclosure. FIG. 19 is an isometric view of a portion of a U-shaped channel 26a according to the embodiment of the present disclosure shown in FIG. 18. As shown in FIG. 18, a wire/cord 130a can extend downwardly from the ceiling 170 to suspend a light module. The wire 130a extends to a mounting bracket assembly 248a. The exemplary mounting bracket assembly 248a includes a swivel post 250a, a bracket 252a, and a set screw 254a. The exemplary 130a extends to the exemplary swivel post 250a. The exemplary swivel post 250a is rotatable connected to the exemplary bracket 252a such that the exemplary bracket 252a can freely rotate about the exemplary swivel post 250a. The exemplary set screw 254a is threadingly received in a threaded aperture defined by the exemplary bracket 252a.

The exemplary channel 26a includes a pair of opposing tracks 258a, 260a at a top surface 160a of the channel 26a. The exemplary bracket 252a includes a pair of wings 262a, 264a. In operation, the exemplary wings 262a, 264a can be aligned with the exemplary tracks 258a, 260a, respectively, at one of the open ends of the channel 26a (one of the ends shown in FIG. 19). The bracket assembly 248a can be then be moved along the tracks 258a, 260a until the bracket assembly 248a is in the desired position. This allows a position of a light module to be adjusted as desired.

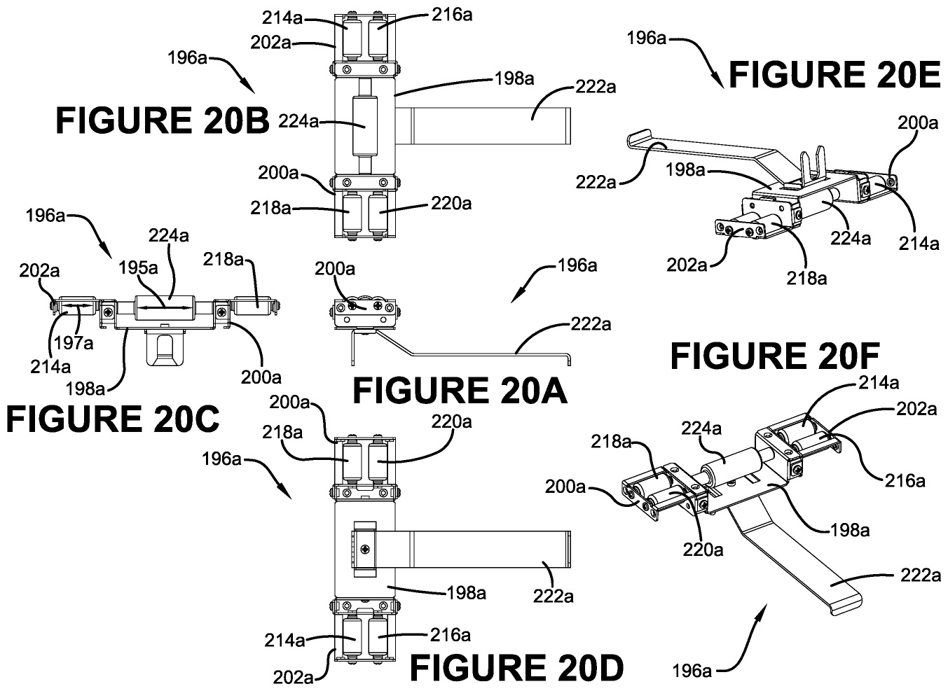

FIGS. 20A-20F are views of a tool 196a used to install a lens when a light module is partially recessed in the ceiling 170. FIG. 20A is a front view, FIG. 20B is a top view, FIG. 20C is a left-hand view, FIG. 20D is a bottom view, FIG. 20E is a first isometric view, and FIG. 20F is a second isometric view. The exemplary tool 196a includes structural members 198a, 200a, 202a; bearings 214a, 216a, 218a, 220a; a tongue 222a; and a roller 224a. In operation, the exemplary bearings 214a, 216a, 218a, 220a roll along the ceiling 170 as the lens is being installed. The exemplary tools 196 and 196a can be formed from substantially the same subcomponents and thus used when a light module is suspended, surface-mounted or recessed. FIG. 13 shows the tool 196 assembled to mount a lens on a suspended light module. The structural members 200 and 202 can be removed to use the tool 196 (as so modified) to mount a lens on a surface-mounted light module. FIGS. 20A-20F show that the tool 196 can be slightly modified to form tool 196a whereby the structural portions supporting bearings 214a, 216a, 218a, 220a are pivoted about structural member 198a relative to the orientation of the bearings 214, 216, 218, 220 to member 198, in order to mount a lens on a recessed-mounted light module.

Exemplary roller 224a is thus mounted on the framework for rotation about a first axis 195a (referenced in FIG. 20c) that is perpendicular to and spaced from the central axis 39 when the framework is positioned on the channel 26 during installation of the lens 22. Exemplary roller 214a is mounted on the framework for rotation about a second axis 197a that is perpendicular to and spaced from the central axis 39 and parallel to the first axis 195a when the framework is positioned on the channel 26 during installation of the lens 22. During an exemplary installation of the lens 22, the framework is moveable along the channel 26 with the roller 224a rollable along the first and second distal ends 33, 35 and urging the lens 22 into the open top 37, the roller 214a rollable along the ceiling 170, and the tongue 222 configured to support a portion of the lens 22.

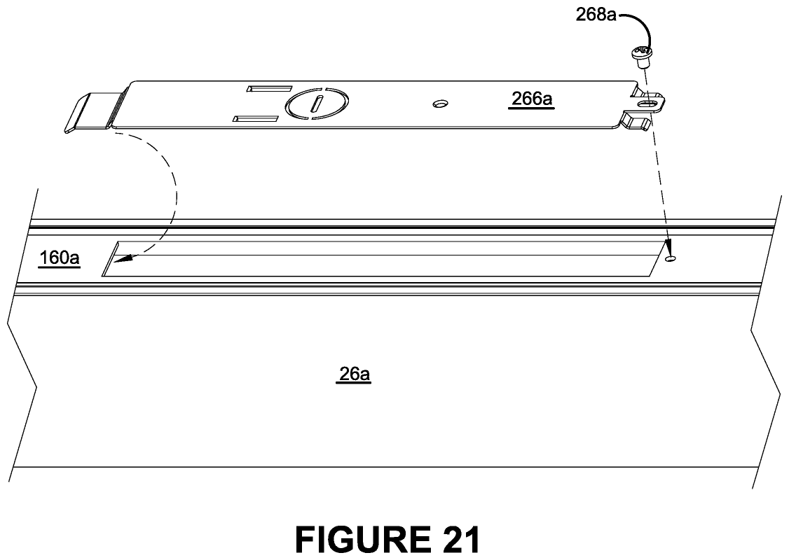

FIG. 21 is a perspective view of another portion of the U-shaped channel 26a shown in FIG. 19. The channel 26a includes a cover 266a on the top surface 160a. The cover 266a can be attached to and removed from the rest of the channel 26a by a screw 268a. The cover 266a can be removed to permit access to driver circuitry and adjust illumination settings. This allows the settings to be changed with removing an end cap of the channel 26a or the lens.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to broadly claim elements and/or sub-combinations that are disclosed herein, such as the positioning bracket assembly and/or the tools for inserting a lens and/or method of inserting a lens, apart from use with the disclosed light module, is hereby unconditionally reserved. The use of the word “can” in this document is not an assertion that the subject preceding the word is unimportant or unnecessary or “not critical” relative to anything else in this document. The word “can” is used herein in a positive and affirming sense and no other motive should be presumed. More than one “invention” may be disclosed in the present disclosure; an “invention” is defined by the content of a patent claim and not by the content of a detailed description of an embodiment of an invention.

What is claimed is:

1. A lighting system comprising:
at least one light module configured to mount to a ceiling in any one of a surface mount arrangement, a recessed mount arrangement, and a pendant mount arrangement, said at least one light module having:
a channel having a bottom wall, first and second side walls projecting away from said bottom wall to respective first and second distal ends, and an open top defined between said first and second distal ends, said channel having a central axis and extending along said central axis between a first end and a second end, wherein said channel further comprises a plurality of punch outs defined in said bottom wall, each of said plurality of punch outs configured to facilitate one of the surface mount arrangement, the recessed mount arrangement, and the pendant mount arrangement;
an array of light emitting diodes (LEDs) disposed in said channel, and arranged along said central axis, and directed toward said open top such that at least a portion of light emitted by said LEDs emanates out of said open top;
a driver for controlling power directed to said array of LEDs;
a lens mountable in said open top between said first and second distal ends;
at least one cap selectively engageable with at least one of said first end and said second end of said channel, said at least one cap removed from said at least one of said first end and second end of said channel when said at least one light module is interconnected with a second light module.

2. The lighting system of claim 1 further comprising at least one of:
a first half of a linking bracket, mountable in said channel, and having a frame and an arm pivotally mounted on said frame and a first aperture extending through said arm; and
a second half of the linking bracket, mountable in said channel, and having a frame and a post and a second aperture adjacent to said post, wherein said first aperture and said second aperture are aligned when said arm is pivoted to rest on said post.

3. The lighting system of claim 1 further comprising:
the second light module; and
a linking bracket including:
a first half mountable in said channel of said at least one light module and having a frame and an arm pivotally mounted on said frame and a first aperture extending through said arm, and
a second half mountable in a channel of said second light module mountable and having a frame and a post and a second aperture adjacent to said post, wherein said first aperture and said second aperture are aligned when said arm is pivoted to rest on said post.

4. The lighting system of claim 3 further comprising:
a fastener receivable in said first aperture and said second aperture wherein, as said fastener is turned to move deeper into said first aperture and said second aperture, said fastener urges said arm downward and wherein said arm and said post 64 operate as a cam/cam-follower such that as said arm moves downward said first half and said second half are drawn together.

5. The lighting system of claim 1 further comprising at least one of:
a first half of a linking bracket, mountable in said channel, and having a hook portion; and
a second half of the linking bracket, mountable in said channel, and having an over-center latch, wherein said over-center latch is selectively engageable with said hook portion.

6. The lighting system of claim 1 further comprising:
the second light module; and
a linking bracket including:
a first half mountable in said channel of said at least one light module and having a hook portion, and
a second half mountable in a channel of said second light module and having an over-center latch, wherein said over-center latch is selectively engageable with said hook portion and urges said at least one light module and said second light module together when engaged with said hook portion.

7. The lighting system of claim 1 further comprising:
a lens installation tool having:
a framework,
at least one first roller mounted on said framework for rotation about a first axis that is perpendicular to and spaced from said central axis when said framework is positioned on said channel during installation of said lens,
at least one second roller mounted on said framework for rotation about a second axis that is perpendicular to and spaced from said central axis and perpendicular to said first axis when said framework is positioned on said channel during installation of said lens,
at least one third roller mounted on said framework for rotation about a third axis that is perpendicular to and spaced from said central axis and perpendicular to said first axis and parallel to said second axis when said framework is positioned on said channel during installation of said lens,
at least one fourth roller mounted on said framework for rotation about a fourth axis that is perpendicular to and spaced from said central axis and parallel to said first axis and perpendicular to said second axis and said third axis when said framework is positioned on said channel during installation of said lens, and
a tongue releasably engaged with said framework and extending from said framework along said central axis;
wherein, during installation of said lens, said framework is moveable along said channel with said at least one first roller rollable along said first and second distal ends and urging said lens into said open top, said at least one second roller and said at least one third roller respectively rollable along said first and second side walls, said at least one fourth roller rollable along said bottom wall, and said tongue configured to support a portion of said lens.

8. The lighting system of claim 1 further comprising:
the second light module configured to mount to the ceiling in any one of a surface mount arrangement, a recessed mount arrangement, and a pendant mount arrangement, said second light module having a second channel with a second open top and a second array of LEDs disposed in said second channel, wherein said lens is mountable in said open top as well as said second open top.

9. The lighting system of claim 1 further comprising:
a lens installation tool having:
a framework,
at least one first roller mounted on said framework for rotation about a first axis that is perpendicular to and spaced from said central axis when said framework is positioned on said channel during installation of said lens,
at least one second roller mounted on said framework for rotation about a second axis that is perpendicular to and spaced from said central axis and parallel to said first axis, and
a tongue releasably engaged with said framework and extending from said framework along said central axis;
wherein, during installation of said lens, said framework is moveable along said channel with said at least one first roller rollable along said first and second distal ends and urging said lens into said open top, said at least one second roller spaced from said first and second side walls and said bottom wall, and said tongue configured to support a portion of said lens.

10. The lighting system of claim 1 further comprising:
a positioning bracket assembly engaged with said channel and configured to transmit at least a portion of a weight of said light module to an upwardly-facing surface of the ceiling and having:
a shaft extending through said channel,
a yoke mounted on said shaft for concurrent rotation, and
a spring operably positioned between said yoke and said channel.

11. The lighting system of claim 10 wherein said yoke and said shaft are rotationally engaged with said channel to move between first and second end limits of travel and said spring torsionally biases said yoke and said shaft toward said first end limit of travel.

12. The lighting system of claim 11 wherein said shaft further comprises a plurality of flat landings for engagement by a tool to rotate said yoke and said shaft against the torsional bias generated by said spring and rotate said yoke and said shaft toward said second end limit of travel.

13. The lighting system of claim 10 wherein said yoke further comprises a plurality of arms, the weight of said light module transmitted to the upwardly-facing surface of the ceiling through said plurality of arms, and each of said plurality of arms at least partially overlaps one of said first and second side walls along a center axis of said shaft.

14. The lighting system of claim 13 wherein said spring further biases said yoke and said channel axially apart and said positioning bracket assembly further comprises:
a second shaft having a threaded end; and
a thread aperture receiving said threaded end, wherein an extent of overlap of said plurality of arms and said first and second side walls along the center axis of said shaft increases in response to rotation of said second shaft in a first direction and decreases in response to rotation of said second shaft in a second direction opposite the first direction.

15. The lighting system of claim 10 wherein said yoke further comprises a plurality of arms, wherein said yoke and said shaft are rotationally engaged with said channel to move between first and second end limits of travel, wherein a first width is defined between respective outer edges of said plurality of arms in a first plane normal to central axis and containing or parallel to a center axis of said shaft when said yoke and said shaft are at said first end limit of travel, wherein a second width is defined between respective outer edges of said plurality of arms in the first plane when said yoke and said shaft are at said second end limit of travel, and wherein said first width is greater than said second width.

16. The lighting system of claim 15 wherein each of said plurality of arms includes a respective tip that tapers toward said channel in the first plane when said yoke and said shaft are at said second end limit of travel.

17. The lighting system of claim 10 wherein said spring further biases said yoke and said channel axially apart and said positioning bracket assembly further comprises:
a second shaft having a threaded end; and
a thread aperture receiving said threaded end, wherein an extent of axial compression of said spring increases in response to rotation of said second shaft in a first direction and decreases in response to rotation of said second shaft in a second direction opposite the first direction.

18. The lighting system of claim 17 wherein said second shaft extends through said shaft.

19. The lighting system of claim 1 further comprising:
a control module selectively engageable with at least one of said first end and said second end of said channel when said at least one cap is removed from said at least one of said first end and second end of said channel and having:
a circuit board;
input/output wiring connecting the circuit board and the driver; and
a light sensor in electronic communication with the circuit board and configured to emit a first signal representative of a magnitude of sensed light, wherein the circuit board is further defined as responsive to the first signal received from the light sensor to direct a second signal to said driver to alter electrical current directed to said array of LEDs.

20. The lighting system of claim 1 further comprising:
a first plug and first wiring extending from said driver along said central axis toward said first end of said channel; and
a second plug and second wiring extending from said driver along said central axis toward said second end of said channel.
